(19) United States
(12) Patent Application Publication
(10) Pub. No.: US 2010/0248100 A1
(43) Pub. Date: Sep. 30, 2010

(54) ELECTROPHOTOGRAPHIC PHOTORECEPTOR, IMAGE-FORMING DEVICE, AND PROCESS CARTRIDGE

(75) Inventor: Tetsuya EZUMI, Kanagawa (JP)

Correspondence Address: OLIFF & BERRIDGE, PLC, P.O. BOX 320850, ALEXANDRIA, VA, 22320-4850, US

(73) Assignee: FUJI XEROX CO., LTD., Tokyo (JP)

(21) Appl. No.: 12/545,506

(22) Filed: Aug. 21, 2009

(30) Foreign Application Priority Data
Mar. 25, 2009 (JP) 2009-074793

(51) Int. Cl. G03G 15/00; G03G 21/18

(52) U.S. Cl. 430/56; 399/111; 430/66; 399/159

(57) ABSTRACT

An electrophotographic photoreceptor includes a conductive support and, on the conductive support, at least a photosensitive layer, the electrophotographic photoreceptor comprising a surface layer that may be the same as or different from the photosensitive layer and that includes fluororesin particles and a fluorinated alkyl group-containing copolymer containing a repeating unit represented by the following Structural Formula A, and the content of quaternary ammonium salt in the surface layer being 50 ppm or less, wherein, in Structural Formula A, l represents a positive number of 1 or more; p represents 0 or a positive number of 1 or more; t represents a positive number of from 1 to 7; R₁ represents a hydrogen atom or an alkyl group; and Q represents —O— or —NH—.

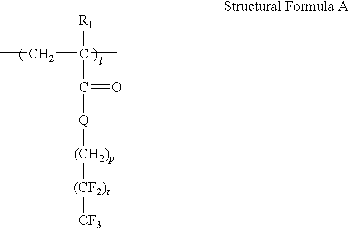

### CROSS-REFERENCE TO RELATED APPLICATION

This application is based on and claims priority under 35 USC 119 from Japanese patent Application No. 2009-074793 filed on Mar. 25, 2009.

### BACKGROUND

1. Technical Field

The present invention relates to an electrophotographic photoreceptor, an image-forming device, and a process cartridge.

2. Related Art

Due to advantages of high speed and high print quality, electrophotographic image formation has been widely used in the fields of copying machines, laser beam printers, and the like. As electrophotographic photoreceptors (hereinafter sometimes simply referred to as “photoreceptors”) for use in image-forming devices, electrophotographic photoreceptors using organic photoconductive materials, which are inexpensive and have excellent in productivity and disposability compared with photoreceptors using inorganic photoconductive materials, have increasingly become mainstream. In particular, layered organic photoreceptors in which a charge generating layer that generates a charge by exposure and a charge transport layer that transports the charge are disposed one on the other have excellent electrophotographic properties, and various proposals have been made thereon and the layered organic photoreceptors are put in practical applications.

Heretofore, methods for increasing the durability of photoreceptors have been studied. For example, a method of reducing the surface energy of a surface layer of a photoreceptor by dispersing fluororesin particles in the surface layer has been proposed.

### SUMMARY

According to an aspect of the invention, there is provided an electrophotographic photoreceptor including a conductive support and, on the conductive support, at least a photosensitive layer,

the electrophotographic photoreceptor including a surface layer that may be the same as or different from the photosensitive layer and that includes fluororesin particles and a fluorinated alkyl group-containing copolymer containing a repeating unit represented by the following Structural Formula A, and

the content of quaternary ammonium salt in the surface layer being 50 ppm or less:

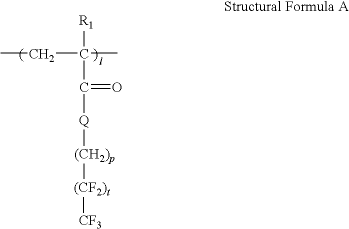

wherein, in Structural Formula A, l represents a positive number of 1 or more; p represents 0 or a positive number of 1 or more; t represents a positive number of from 1 to 7; R₁ represents a hydrogen atom or an alkyl group; and Q represents —O— or —NH—.

### BRIEF DESCRIPTION OF THE DRAWINGS

Exemplary embodiments of the present invention will be described in detail based on the following figures, wherein:

FIG. 1 is a cross sectional view illustrating an example of an electrophotographic photoreceptor according to an exemplary embodiment; and

FIG. 2 is a view illustrating the overall structure of an example of an image-forming device according to an exemplary embodiment.

### DETAILED DESCRIPTION

Hereinafter, exemplary embodiments of the electrophotographic photoreceptor, the image-forming device, and the process cartridge of the present invention are described in detail.

### Electrophotographic Photoreceptor

An electrophotographic photoreceptor according to an exemplary embodiment includes a conductive support and, on the conductive support, at least a photosensitive layer. The electrophotographic photoreceptor has a surface layer, which may be the same as or different from the photosensitive layer, and the surface layer contains a fluorinated alkyl group-containing copolymer containing a repeating unit represented by the following Structural Formula A (hereinafter, sometimes referred to as a “fluorinated alkyl group-containing copolymer according to the present exemplary embodiment) and fluororesin particles, and the content of quaternary ammonium salt in the surface layer is 50 ppm or less (or about 50 ppm or less).

In the present exemplary embodiment, “conductive” means that the volume resistivity is lower than 10⁷ Ω·cm.

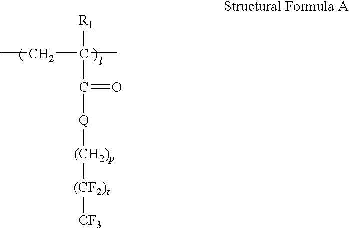

In Structural Formula A, l represents a positive number of 1 or more, p represents 0 or a positive number of 1 or more, t represents a positive number of 1 to 7, R₁ represents a hydrogen atom or an alkyl group, and Q represents —O— or —NH—.

In the present exemplary embodiment, the content of quaternary ammonium salt in the surface layer refers to a value quantified by HPLC. Specifically, the content of quaternary ammonium salt is determined by peeling off the surface layer of the electrophotographic photoreceptor, pulverizing the surface layer, subjecting 5 g of the pulverized surface layer to a solvent extraction with 95 g of acetonitrile, and measuring the amount of quaternary ammonium salt in the extract by HPLC under the following conditions.

Specifically, the analysis is performed under the following conditions:

Measuring apparatus: HP1100 (tradename), manufactured by Hewlett Packard,

Column: INERTSIL ODS3 (tradename),

Mobile phase: CH₃CN/5 mM sodium hexasulfonate at a ratio of 95/5,

Flow rate: 1.0 ml/min,

Temperature: 40° C.,

Injection amount: 30 ml,

Detector: UV detector.

Fluororesin particles have low dispersibility and high cohesiveness. Therefore, in conventional techniques, when fluororesin particles are contained in a surface layer of an electrophotographic photoreceptor, the distribution of the fluororesin particles in the surface layer is likely to be non-uniform. As a result, the film thickness of a coating film is likely to be non-uniform due to aggregation of the fluororesin particles, which has, in some cases, made it difficult to stably obtain favorable film formation properties. In particular, when the film thickness of a photosensitive layer is increased in order to extend the life time, the non-uniformity may become large, and it has been difficult to obtain a favorable photosensitive layer film depending on cases.

In conventional techniques, when extension of the life time of the electrophotographic photoreceptor is aimed at, residual potential is accumulated in the film due to electrical stress applied to the photoreceptor during the use of the photoreceptor over a prolonged period of time; as a result, image quality defects, such as image fogging, are likely to occur in reversal development, and it has been difficult to maintain favorable image quality depending on cases.

In order to achieve both electrophotographic property and durability of the electrophotographic photoreceptor at a high level, the present inventor has first studied a surface layer containing fluororesin particles and a fluorinated alkyl group-containing copolymer used as a dispersing agent for dispersing the fluororesin particles. As a result, the present inventor has found that the decrease in image density due to an increase in residual potential results from the presence of the fluorinated alkyl group-containing copolymer in a free form in the surface layer and that increase in the amount of quaternary ammonium salt in the surface layer increases the tendency for the residual potential to increase.

More specifically, the addition amount of the fluorinated alkyl group-containing copolymer tends to exceed a required amount, so that excessive fluorinated alkyl group-containing copolymer that are not adsorbed to the surface of the fluororesin particles is present in the surface layer in a free form. This free fluorinated alkyl group-containing copolymer sometimes causes development of a trap site at which electric charge is accumulated. Therefore, when repeatedly used at high temperature and high humidity, the image density may tend to decrease due to an increased residual potential.

Since quaternary ammonium salt is used as a catalyst for synthesizing the fluorinated alkyl group-containing copolymer, the quaternary ammonium salt remains in the fluorinated alkyl group-containing copolymer. Therefore, when the addition amount of the fluorinated alkyl group-containing copolymer is increased, the amount of quaternary ammonium salt in the film also increases. Similarly to the free fluorinated alkyl group-containing copolymer, the quaternary ammonium salt serves as a substance causing the development of a trap site at which charge is accumulated, and thus, may increase residual potential.

The present inventor has found that when the amount of quaternary ammonium salt in the surface layer is 50 ppm or less, an electrophotographic photoreceptor in which an increase in residual potential is inhibited and electrophotographic properties are excellent may be obtained.

The fluorinated alkyl group-containing copolymer according to the present exemplary embodiment contains a repeating unit represented by Structural Formula A. When t in Structural Formula A is 0, the adsorptivity of the fluorinated alkyl group-containing copolymer to the fluororesin particles decreases, and thus the function as a dispersing agent decreases in some cases. When the dispersibility of the fluororesin particles decreases, the distribution of the fluororesin particles present in the surface layer become non-uniform, which sometimes makes it difficult to obtain an effect in sufficiently improving durability of the electrophotographic photoreceptor.

When t in Structural Formula A is 8 or more, the compatibility of the fluorinated alkyl group-containing copolymer with a binder resin contained in the surface layer deteriorates in some cases. Therefore, the interface between the fluorinated alkyl group-containing copolymer and the binder resin serves as a trap site, as a result of which reduction in image density tends to occur due to an increase in residual potential during repeated use at high temperature and high humidity.

In contrast, when t in Structural Formula A is from 1 to 7, the compatibility with the binder resin contained in the surface layer may be imparted to the fluorinated alkyl group-containing copolymer while maintaining the adsorptivity of the fluorinated alkyl group-containing copolymer toward the fluororesin particles. A preferable range of t in Structural Formula A is from 2 to 6.

The fluorinated alkyl group-containing copolymer may be purified as required. The purification is performed by using, as necessary, a purification method, such as a re-precipitation method or a chromatography method, which may be combined with heating treatment, high pressure nozzle treatment using a nanomizer, a microfluidizer, or the like, ultrasonic treatment, or the like. By subjecting the fluorinated alkyl group-containing copolymer to purification treatment, the content of quaternary ammonium salt in the fluorinated alkyl group-containing copolymer is decreased.

The layer structure of the electrophotographic photoreceptor according to the present exemplary embodiment is not limited insofar as it has at least a photosensitive layer on a conductive support and a surface layer thereof contains the fluorinated alkyl group-containing copolymer according to the present exemplary embodiment and the fluororesin particles. The photosensitive layer according to the present exemplary embodiment may be an integrated-function photosensitive layer having both charge transport ability and charge generation ability or may be a layered photosensitive layer containing a charge transporting layer and a charge generating layer. Furthermore, other layers, such as an undercoat layer, an intermediate layer, or a protective layer, may be provided as required.

In the electrophotographic photoreceptor according to the present exemplary embodiment, when the integrated-function photosensitive layer serves as the surface layer, the fluorinated alkyl group-containing copolymer according to the present exemplary embodiment and the fluororesin particles are contained in the integrated-function photosensitive layer. When either one of a charge transporting layer or a charge generating layer contained in the function-separated photosensitive layer serves as the surface layer, the fluorinated alkyl group-containing copolymer according to the present exemplary embodiment and the fluororesin particles are contained in a layer corresponding to the surface layer. When a protective layer is provided as a surface layer on the photosensitive layer, the fluorinated alkyl group-containing copolymer according to the present exemplary embodiment and the fluororesin particles are contained in the protective layer.

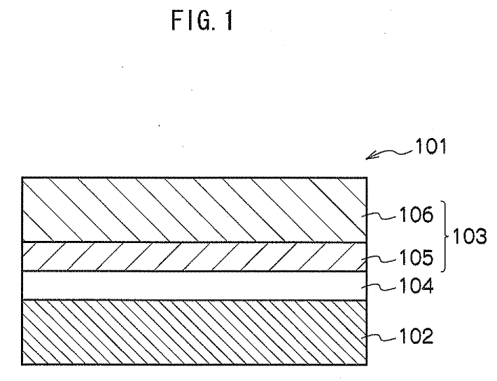

FIG. 1 is a cross sectional view illustrating one example of the electrophotographic photoreceptor according to the present exemplary embodiment. An electrophotographic photoreceptor 101 according to FIG. 1 has a structure in which an undercoat layer 104, a charge generating layer 105, and a charge transporting layer 106 are disposed in this order on a conductive support 102, and the charge generating layer 105 and the charge transporting layer 106 constitute a layered photosensitive layer 103. Here, the charge transporting layer 106 is a surface layer (the layer furthest from the conductive support 102) of the electrophotographic photoreceptor 101. In the electrophotographic photoreceptor illustrated in FIG. 1, the fluorinated alkyl group-containing copolymer according to the present exemplary embodiment and the fluororesin particles are contained in the charge transporting layer 106.

Each component of the electrophotographic photoreceptor 101 is described below.

The conductive support 102 may be any material that has been used as a conductive support. Examples thereof include: metals, such as aluminum, nickel, chromium, and stainless steel; plastic films having a thin film of, for example, aluminum, titanium, nickel, chromium, stainless steel, gold, vanadium, tin oxide, indium oxide, or ITO; and a paper or plastic film that is coated with, or impregnated with, a conductivity imparting agent. The shape of the conductive support 102 is not limited to a drum shape, and may be a sheet shape or a plate shape.

When a metal pipe is used as the conductive support 102, the surface there of may be the surface of a bare metal pipe itself, or may be subjected beforehand to treatment, such as mirror grinding, etching, anodic oxidation, coarse grinding, centerless grinding, sandblasting, or wet honing.

The undercoat layer 104 may be provided as required for the purposes of, for example, preventing light reflection at the surface of the conductive support 102, preventing inflow of unnecessary carrier from the conductive support 102 into the photosensitive layer 103. Examples of the material of the undercoat layer 104 include a material in which metal powder such as powder of aluminum, copper, nickel, or silver, a conductive metal oxide such as antimony oxide, indium oxide, tin oxide, or zinc oxide, or a conductive substance such as carbon fiber, carbon black, or graphite powder, is dispersed in a binder resin, and the material may be applied onto the support. A mixture of two or more kinds of metal oxide particles may be used. The metal oxide particles may be subjected to surface treatment with a coupling agent, so as to regulate the powder resistance thereof.

Examples of the binder resin contained in the undercoat layer 104 include: known polymer resin compounds, such as acetal resins (such as polyvinyl butyral), polyvinyl alcohol resins, casein, polyamide resins, cellulose resins, gelatin, polyurethane resins, polyester resins, methacrylic resins, acrylic resins, polyvinyl chloride resins, polyvinyl acetate resins, vinyl chloride-vinyl acetate-maleic anhydride resins, silicone resins, silicone-alkyd resins, phenol resins, phenol-formaldehyde resins, melamine resins, and urethane resins; charge transporting resins having charge transporting groups, and a conductive resin such as polyaniline. In particular, resins insoluble in a coating solvent of the upper layer is preferably used, and phenol resins, phenol-formaldehyde resins, melamine resins, urethane resins, epoxy resins, and the like are more preferably used.

The ratio of the metal oxide particles to the binder resin in the undercoat layer 104 is not particularly limited, and may be determined in the range in which desired electrophotographic photoreceptor properties are obtained.

When the undercoat layer 104 is formed, a coating liquid obtained by adding the ingredients mentioned above to a solvent may be used. The solvent may be an organic solvent, and examples thereof include aromatic hydrocarbon solvents, such as toluene or chlorobenzene; aliphatic alcohol solvents, such as methanol, ethanol, n-propanol, iso-propanol, or n-butanol; ketone solvents, such as acetone, cyclohexanone, or 2-butanone; halogenated aliphatic hydrocarbon solvents, such as methylene chloride, chloroform, or ethylene chloride; cyclic or straight chain ether solvents, such as tetrahydrofuran, dioxane, ethylene glycol, or diethyl ether; and ester solvents, such as methyl acetate, ethyl acetate, or n-butyl acetate. The solvent may be used singly or in a mixture of two or more thereof. When solvents are mixed and used, the solvents used are not particularly limited insofar as the solvents, when mixed, can dissolve the binder resin as a mixed solvent.

For a method for dispersing metal oxide particles in the coating liquid for forming the undercoat layer, a media disperser, such as a ball mill, a vibration ball mill, an attritor, a sand mill, or a horizontal-type sand mill, or a medialess disperser, such as a stirrer, an ultrasonic disperser, a roll mill, or a high-pressure homogenizer, may be used. Examples of the high-pressure homogenizer include a homogenizer using a collision method including subjecting a dispersion liquid to liquid-liquid collision or liquid-wall collision at high pressure so as to perform dispersing and a homogenizer using a flow-through method including allowing the dispersion liquid to flow through a fine flow path at high pressure so as to perform dispersing.

Examples of a method for applying the coating liquid for forming the undercoat layer thus obtained to the conductive support 102 include a dip coating method, a push-up coating method, a wire bar coating method, a spray coating method, a blade coating method, a knife coating method, and a curtain coating method. The thickness of the undercoat layer 104 is preferably 15 μm or more and more preferably from 20 μm to 50 μm. In the undercoat layer 104, resin particles may be contained so as to adjust the surface roughness. The resin particles may be silicone resin particles, crosslinked PMMA resin particles, or the like.

The surface of the undercoat layer 104 may be polished for adjusting the surface roughness. Examples of the polishing method to be used include buff polishing, sandblast treatment, wet honing, and grinding treatment.

Although not illustrated in the figure, an intermediate layer may be further provided on the undercoat layer 104 with a view to improving, for example, electrical characteristics, image quality, maintenance of image quality, and adhesion to the photosensitive layer. Examples of the binder resin for use in the intermediate layer include: polymer resin compounds, such as acetal resins (such as polyvinyl butyral), polyvinyl alcohol resins, casein, polyamide resins, cellulose resins, gelatin, polyurethane resins, polyester resins, methacrylic resins, acrylic resins, polyvinyl chloride resins, polyvinyl acetate resins, vinyl chloride-vinyl acetate-maleic anhydride resins, silicone resins, silicone-alkyd resins, phenol-formaldehyde resins, and melamine resins; organometallic compounds containing, for example, zirconium, titanium, aluminum, manganese, or silicon. Any of these compounds may be used singly, or two or more of these compounds may be used as a mixture or a polycondensate thereof. In particular, organometallic compounds containing zirconium or silicon may have excellent performances, for example in that the residual potential is low, variation in the electric potential in varied environments is small, and change in the electric potential caused by repeated use is small.

The solvent used for forming the intermediate layer may be a known organic solvent, and examples thereof include: aromatic hydrocarbon solvents, such as toluene or chlorobenzene; aliphatic alcohol solvents, such as methanol, ethanol, n-propanol, iso-propanol, or n-butanol; ketone solvents, such as acetone, cyclohexanone, or 2-butanone; halogenated aliphatic hydrocarbon solvents, such as methylene chloride, chloroform, or ethylene chloride; cyclic or straight-chain ether solvents, such as tetrahydrofuran, dioxane, ethylene glycol, or diethyl ether; and ester solvents, such as methyl acetate, ethyl acetate, or n-butyl acetate. The solvent may be used singly or in a mixture of two or more thereof. When solvents are mixed and used, the solvents used are not particularly limited insofar as the solvents, when mixed, can dissolve the binder resin as a mixed solvent.

The coating method for forming the intermediate layer may be an ordinary method, such as a dip coating method, a push-up coating method, a wire bar coating method, a spray coating method, a blade coating method, a knife coating method, or a curtain coating method.

The intermediate layer also functions as an electrical blocking layer in addition to improving coatability of the upper layer. However, when the thickness of the intermediate layer is excessively large, the electric barrier becomes excessively strong, thereby causing desensitization or an increase in potential over repetition. Therefore, when the intermediate layer is formed, the thickness thereof is adjusted to be in the range of 0.1 μm to 3 μm. The intermediate layer in this case may be used as the undercoat layer 104.

The charge generating layer 105 is formed by dispersing a charge generating material in an appropriate binder resin. Examples of such a charge generating material include phthalocyanine pigments, such as metal-free phthalocyanine, chlorogallium phthalocyanine, hydroxygallium phthalocyanine, dichlorotin phthalocyanine, or titanylphthalocyanine. In particular, a chlorogallium phthalocyanine crystal having strong diffraction peaks at Bragg angles (2θ±0.2°) to CuKα characteristic X-rays of at least 7.4°, 16.6°, 25.5°, and 28.3°, a metal-free phthalocyanine crystal having strong diffraction peaks at Bragg angles (2θ±0.2°) to CuKα characteristic X-rays of at least 7.7°, 9.3°, 16.9°, 17.5°, 22.4°, and 28.8°, a hydroxygallium phthalocyanine crystal having strong diffraction peaks at Bragg angles (2θ±0.2°) to CuKα characteristic X-rays of at least 7.5°, 9.9°, 12.5°, 16.3°, 18.6°, 25.1°, and 28.3°, or a titanylphthalocyanine crystal having strong diffraction peaks at Bragg angles (2θ±0.2°) to CuKα characteristic X-rays of at least 9.6°, 24.1°, and 27.2° may be used. Examples of the charge generating material further include quinone pigments, perylene pigments, indigo pigments, bisbenzimidazole pigments, anthrone pigments, and quinacridone pigments. The charge generating material may be used singly or in a mixture of two or more thereof.

Examples of the binder resin in the charge generating layer 105 include polycarbonate resins, such as bisphenol A polycarbonate resins and bisphenol Z polycarbonate resins, acrylic resins, methacrylic resins, polyarylate resins, polyester resins, polyvinyl chloride resins, polystyrene resins, acrylonitrile-styrene copolymer resins, acrylonitrile-butadiene copolymers, polyvinyl acetate resins, polyvinyl formal resins, polysulfone resins, styrene-butadiene copolymer resins, vinylidene chloride-acrylonitrile copolymer resins, vinyl chloride-vinyl acetate-maleic anhydride resins, silicone resins, phenol-formaldehyde resins, polyacrylamide resins, polyamide resins, and poly-N-vinylcarbazole resins. The binder resin may be used singly or in a mixture of two or more thereof. The blending ratio of the charge generating material to the binder resin may be in the range of 10:1 to 1:10.

When the charge generating layer 105 is formed, a coating liquid obtained by adding the ingredients mentioned above to a solvent may be used. The solvent may be an organic solvent, and examples thereof include: aromatic hydrocarbon solvents, such as toluene or chlorobenzene; aliphatic alcohol solvents, such as methanol, ethanol, n-propanol, iso-propanol, or n-butanol; ketone solvents, such as acetone, cyclohexanone, or 2-butanone; halogenated aliphatic hydrocarbon solvents, such as methylene chloride, chloroform, or ethylene chloride; cyclic or straight-chain ether solvents, such as tetrahydrofuran, dioxane, ethylene glycol, or diethyl ether; and ester solvents, such as methyl acetate, ethyl acetate, or n-butyl acetate. The solvent may be used singly or in a mixture of two or more thereof. When solvents are mixed and used, the solvents used are not particularly limited insofar as the solvents, when mixed, can dissolve the binder resin as a mixed solvent.

In order to disperse the charge generating material in resin, the coating liquid may be subjected to dispersion treatment. The dispersing may be performed using a media disperser, such as a ball mill, a vibration ball mill, an attritor, a sand mill, or a horizontal-type sand mill or a medialess disperser, such as a stirrer, an ultrasonic dispersers a roll mill, or a high pressure homogenizer. Examples of the high pressure homogenizer include a collision method including subjecting a dispersion liquid to liquid-liquid collision or liquid-wall collision at high pressure so as to perform dispersing and a flow-through method including allowing the dispersion liquid to flow through a fine flow path at high pressure so as to perform dispersing.

Examples of a method for applying the coating liquid thus obtained to the undercoat layer 104 include a dip coating method, a push-up coating method, a wire bar coating method, a spray coating method, a blade coating method, a knife coating method, and a curtain coating method. The thickness of the charge generating layer 105 is preferably from 0.1 μm to 5 μm and more preferably from 0.05 μm to 2.0 μm.

The charge transporting layer 106 corresponds to the surface layer of the electrophotographic photoreceptor 101, and contains the fluorinated alkyl group-containing copolymer according to the present exemplary embodiment and fluororesin particles as described above.

The fluorinated alkyl group-containing copolymer according to the present exemplary embodiment is a fluorinated alkyl group-containing copolymer containing the repeating unit represented by Structural Formula A. The fluorinated alkyl group-containing copolymer according to the present exemplary embodiment may further contain a repeating unit represented by the following Structural Formula B.

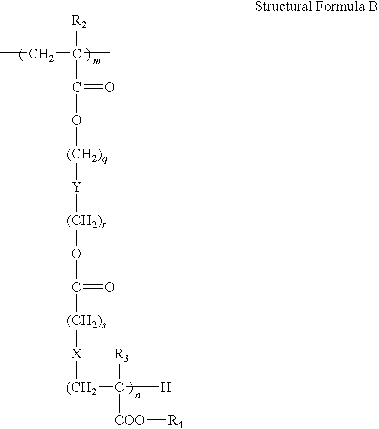

In Structural Formula B, m and n each independently represent a positive number of 1 or more, q, r, and s each independently represent 0 or a positive number of 1 or more, R₂, R₃, and R₄ each independently represent a hydrogen atom or an alkyl group, X represents an alkylene chain, a halogen-substituted alkylene chain, —S—, —O—, —NH—, or a single bond, Y represents an alkylene chain, a halogen-substituted alkylene chain, —(C_{z}H_{2z-1}(OH))—, or a single bond, and z represents a positive number of 1 or more.

When the fluorinated alkyl group-containing copolymer according to the present exemplary embodiment contains the repeating units represented by Structural Formula A and Structural Formula B, the fluorinated alkyl group-containing copolymer according to the present exemplary embodiment may be a resin synthesized by graft polymerization using a macromonomer formed from at least one of an acrylate compound, a methacrylate compound, or the like, and at least one of a perfluoroalkyl ethyl (meth)acrylate or a perfluoroalkyl (meth)acrylate. Here, “(meth)acrylate” refers to acrylate or methacrylate.

In the fluorinated alkyl group-containing copolymer according to the present exemplary embodiment, the content ratio of Structural Formula A to Structural Formula B, which is l:m, is preferably in the range of 1:9 to 9:1 and more preferably in the range of 3:7 to 7:3. When l:m is in the range of 1:9 to 9:1, the fluororesin particles are dispersed well.

In Structural Formula A and Structural Formula B, examples of the alkyl group represented by R₁, R₂, R₃, or R₄ include a methyl group, an ethyl group, and a propyl group. R₁, R₂, R₃, and R₄ each independently represent preferably a hydrogen atom or a methyl group, and more preferably a methyl group.

The fluorinated alkyl group-containing copolymer according to the present exemplary embodiment may further contain a repeating unit represented by Structural Formula C.

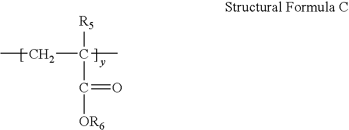

In Structural Formula C, R₅ and R₆ each independently represent a hydrogen atom or an alkyl group, and y represents a positive number of 1 or more.

In Structural Formula C, examples of the alkyl group represented by R₅ or R₆ include a methyl group, an ethyl group, and a propyl group. R₅ and R₆ each independently represent preferably a hydrogen atom or a methyl group, and more preferably a methyl group.

The fluorinated alkyl group-containing copolymer according to the present exemplary embodiment includes a repeating unit represented by Structural Formula A, and there are no other restrictions. The fluorinated alkyl group-containing copolymer may include a repeating unit represented by Structural Formula A and a repeating unit represented by Structural Formula B, or may include a repeating unit represented by Structural Formula A and a repeating unit represented by Structural Formula C, or may include a repeating unit represented by Structural Formula A, a repeating unit represented by Structural Formula B, and a repeating unit represented by Structural Formula C.

When the fluorinated alkyl group-containing copolymer according to the present exemplary embodiment contains a repeating unit represented by Structural Formula A, a repeating unit represented by Structural Formula B, and a repeating unit represented by Structural Formula C, the ratio of the total content (l+m) of the repeating unit represented by Structural Formula A and the repeating unit represented by Structural Formula B to the content of the repeating unit represented by Structural Formula C, which is a ratio represented by (l+m):y, is preferably in the range of 10:0 to 7:3 and more preferably in the range of 9:1 to 7:3.

The content of the fluorinated alkyl group-containing copolymer according to the present exemplary embodiment in the surface layer, i.e., the charge transporting layer 106, is preferably from 1 weight % to 5 weight % (or from about 1 weight % to about 5 weight %), and more preferably from 2 weight % to 4 weight %, with respect to the content (weight basis) of the fluororesin particles in the surface layer. When the content of the fluorinated alkyl group-containing copolymer according to the present exemplary embodiment is 1 weight % or more, the fluororesin particles may be uniformly dispersed in the charge transporting layer 106. When the content of the fluorinated alkyl group-containing copolymer according to the present exemplary embodiment is 5 weight % or lower, the amount of the fluorinated alkyl group-containing copolymer according to the present exemplary embodiment that is not adsorbed onto the surface of the fluororesin particles in the charge transporting layer 106 may be reduced, and development of charge trap sites resulting from the fluorinated alkyl group-containing copolymer according to the present exemplary embodiment in the free form may be prevented. Moreover, the amount of quaternary ammonium salt in the layer may also be reduced. As a result, an electrophotographic photoreceptor in which increase in residual potential and decrease in image density are suppressed even during repeated use at high temperature and high humidity may be obtained.

The content of the fluororesin particles to the total solid content of the surface layer, i.e., the charge transporting layer 106, is preferably from 1 weight % to 15 weight % (or from about 1 weight % to about 15 weight %) and more preferably from 2 weight % to 12 weight %. When the content of the fluororesin particles is 1 weight % or more, the surface energy of the charge transporting layer 106 may be decreased, resulting in an increase in the durability of the electrophotographic photoreceptor. When the content of fluororesin particles is 15 weight % or lower, light transmittance and film strength may be less likely to decrease.

As the fluororesin particles, it is preferable to select at least one of, or two or more of, tetrafluoroethylene resin (PTFE), chlorotrifluoroethylene resin, hexafluoro propylene resin, vinyl fluoride resin, vinylidene fluoride resin, dichlorodifluoroethylene resin, and copolymers thereof. Tetrafluoroethylene resin and vinylidene fluoride resin are more preferable, and tetrafluoroethylene resin is particularly preferable. When the fluororesin particles according to the present exemplary embodiment contain tetrafluoroethylene resin, wear resistance is improved.

The average primary particle diameter of the fluororesin particles is preferably from 0.05 μm to 1 μm and is more preferably from 0.1 μm to 0.5 μm. When the average primary particle diameter is 0.05 μm or more, the aggregation may be less likely to progress at the time of dispersion. When the average primary particle diameter is 1 μm or less, image quality defects may be less likely to occur.

In the present exemplary embodiment, the average primary particle diameter of the fluororesin particles refers to a value measured by the following method.

A measurement liquid obtained by dispersing the fluororesin particles in the same solvent as that of the dispersion liquid containing the fluororesin particles dispersed therein, is measured at a refractive index of 1.35 using a laser diffraction type particle size distribution measuring device LA-700 (manufactured by Horiba).

The charge transporting layer 106 contains, in addition to the ingredients mentioned above, a charge transporting material for serving the intrinsic function of the charge transporting layer and, further, a binder resin. Examples of such a charge transporting material include: hole transporting substances such as

oxadiazole derivatives, such as 5-bis(p-diethylaminophenyl)-1,3,4-oxadiazole,

pyrazoline derivatives, such as 1,3,5-triphenyl-pyrazoline and 1-[pyridyl-(2)]-3-(p-diethylaminostyryl)-5-(p-diethylaminostyryl) pyrazoline,

aromatic tertiary amino compounds, such as triphenylamine, N,N′-bis(3,4-dimethylphenyl) biphenyl 4-amine, tri(p-methylphenyl)aminyl-4-amine, and dibenzylaniline,

aromatic tertiary diamino compounds, such as N,N′-bis(3-methylphenyl)-N,N′-diphenylbenzidine,

1,2,4-triazine derivatives, such as 3-(4′-dimethylamino phenyl)-5,6-di-(4′-methoxypheny)-1,2,4-triazine,

hydrazone derivatives, such as 4-diethylaminobenzaldehyde-1,1-diphenylhydrazone,

quinazoline derivatives, such as 2-phenyl-4-styryl-quinazoline,

benzofuran derivatives, such as 6-hydroxy-2,3-di(p-methoxypheny)benzofuran,

α-stilbene derivatives, such as p-(2,2-diphenylvinyl)-N,N-diphenylaniline,

carbazole derivatives, such as enamine derivatives and N-ethylcarbazole, and

poly-N-vinylcarbazole and derivatives thereof; electron transporting substances, such as

quinone compounds, such as chloranil and bromoanthraquinone,

tetracyano quinodimethane compounds,

fluorenone compounds, such as 2,4,7-trinitrofluorenone and 2,4,5,7-tetranitro-9-fluorenone,

xanthone compounds, and thiophene compounds; and polymers having, in the main chain or at a side chain, a group derived from any of the above compounds. The charge transporting material may be used singly or in combination of two or more thereof.

Examples of the binder resin in the charge transporting layer 106 include: insulating resins, such as polycarbonate resins (such as bisphenol A polycarbonate resins and bisphenol Z polycarbonate resins), acrylic resins, methacrylic resins, polyarylate resins, polyester resins, polyvinyl chloride resins, polystyrene resins, acrylonitrile-styrene copolymer resins, acrylonitrile-butadiene copolymer resins, polyvinyl acetate resins, polyvinyl formal resins, polysulfone resins, styrene-butadiene copolymer resins, vinylidene chloride-acrylonitrile copolymer resins, vinyl chloride-vinyl acetate-maleic anhydride resins, silicone resins, phenol-formaldehyde resins, polyacrylamide resins, polyamide resins, and chloride rubber; and organic photoconductive polymers, such as polyvinyl carbazole, polyvinyl anthracene, and polyvinyl pyrene. The binder resin may be used singly or in a mixture of two or more thereof.

The charge transporting layer 106 may be formed using a coating liquid (coating liquid for forming the charge transporting layer) obtained by adding the ingredients mentioned above to a solvent. The solvent for use in the formation of the charge transporting layer may be a known organic solvent, and examples thereof include: aromatic hydrocarbon solvents, such as toluene or chlorobenzene; aliphatic alcohol solvents, such as methanol, ethanol, n-propanol, iso-propanol, or n-butanol; ketone solvents, such as acetone, cyclohexanone, or 2-butanone; halogenated aliphatic hydrocarbon solvents, such as methylene chloride, chloroform, or ethylene chloride; cyclic or straight-chain ether solvents, such as tetrahydrofuran, dioxane, ethylene glycol, or diethyl ether; and ester solvents, such as methyl acetate, ethyl acetate, or n-butyl acetate. The solvent may be used singly or in a mixture of two or more thereof. When solvents are mixed and used, the solvents used are not particularly limited insofar as the solvents, when mixed, can dissolve the binder resin as a mixed solvent. The blending ratio of the charge transporting material to the binder resin may be in the range of 10:1 to 1:5.

In order to improve the smoothness of the surface of an electrophotographic photoreceptor, a leveling agent, such as silicone oil or fluorine-containing oil, may be incorporated into the charge transporting layer 106.

The content of the leveling agent in the charge transporting layer 106 is preferably from 0.1 ppm to 1000 ppm and more preferably from 0.5 ppm to 500 ppm. When the content is 0.1 ppm or more, a sufficiently smooth surface may be obtained. When the content is 1000 ppm or less, phenomenon that is unfavorable in terms of electrical characteristics, such as increase in the residual potential during repeated use, may be prevented.

The dispersion method for dispersing the fluororesin particles in the coating liquid for forming the charge transporting layer, which is used for forming the charge transporting layer 106, may be a method using a media disperser, such as a ball mill, a vibration ball mill, an attritor, a sand mill, or a horizontal-type sand mil or a medialess disperser, such as a stirrer, an ultrasonic disperser, a roll mill, or a high pressure homogenizer. Examples of the high-pressure homogenizer include a homogenizer using a collision method including subjecting a dispersion liquid to liquid-liquid collision or liquid-wall collision at high pressure so as to perform dispersing and a homogenizer using a flow-through method including allowing the dispersion liquid to flow through a fine flow path at high pressure so as to perform dispersing.

In the present exemplary embodiment, the method for preparing the coating liquid for forming the charge transporting layer is not limited. The coating liquid for forming the charge transporting layer may be prepared by mixing fluororesin particles, the fluorinated alkyl group-containing copolymer according to the present exemplary embodiment, a binder resin, a charge transporting material, and a solvent and, as required, other ingredients and dispersing the mixture using the disperser mentioned above, or may alternatively be prepared by separately preparing two liquids, which are a mixed liquid A containing fluororesin particles, the fluorinated alkyl group-containing copolymer according to the present exemplary embodiment, and a solvent and a mixed liquid B containing a binder resin, a charge transporting material, and a solvent, and mixing the mixed liquid A and mixed liquid B. By mixing the fluororesin particles and the fluorinated alkyl group-containing copolymer according to the present exemplary embodiment in a solvent, the fluorinated alkyl group-containing copolymer according to the present exemplary embodiment may sufficiently adsorb onto the surface of the fluororesin particles.

Moreover, the coating liquid for forming the charge transporting layer may be prepared by adding fluororesin particles and the fluorinated alkyl group-containing copolymer according to the present exemplary embodiment to a solvent containing a binder resin to prepare a mixed liquid A′, and mixing the mixed liquid A′ and the mixed liquid B. The sensitivity of the electrophotographic photoreceptor may be increased by forming the charge transporting layer using the coating liquid for forming the charge transporting layer prepared using the mixed liquid A′, which is obtained by adding fluororesin particles and the fluorinated alkyl group-containing copolymer according to the present exemplary embodiment to a solvent that already contains a binder resin.

The amount of the binder resin contained in the mixed liquid A′ is preferably from 1 weight % to 70 weight %, and more preferably 5 weight % to 30 weight %, relative to the fluororesin particles.

The method for applying the coating liquid for forming the charge transporting layer thus obtained to the charge generating layer 105 may be an ordinary method, such as a dip coating method, a push-up coating method, a wire bar coating method, a spray coating method, a blade coating method, a knife coating method, or a curtain coating method. The thickness of the charge transporting layer is preferably in the range of 5 μm to 50 μm and more preferably in the range of 10 μm to 40 μm.

In order to prevent deterioration of the photoreceptor due to ozone or nitrogen oxides generated in the image-forming device or due to light or heat, additives, such as an antioxidant, a light stabilizer, or a thermostabilizer, may be added to the respective layer(s) that form the photosensitive layer 103. Examples of the antioxidant include hindered phenol, hindered amine, paraphenylenediamine, arylalkane, hydroquinone, spirochroman, spiroindanone, derivatives thereof organic sulfur compounds, and organic phosphorus compounds. Examples of the light stabilizer include benzophenone, benzoazole, dithiocarbamate, and tetramethylpipen, and derivatives thereof.

In the electrophotographic photoreceptor according to the present exemplary embodiment, a protective layer may be provided as the surface layer. The protective layer is used for preventing chemical changes of the charge transporting layer at the time of charging the electrophotographic photoreceptor or for further improving the mechanical strength of the photosensitive layer. The protective layer may be formed by applying a coating liquid in which a conductive material is contained in an appropriate binder resin onto a photosensitive layer.

The conductive material is not particularly limited, and examples thereof include: metallocene compounds such as N,N′-dimethylferrocene; aromatic amine compounds such as N,N′-diphenyl-N,N′-bis(3-methylphenyl)-[1,1′-biphenyl]-4,4′-diamine; molybdenum oxide; tungsten oxide; antimony oxide; tin oxide; titanium oxide; indium oxide; a carrier of a solid solution of tin oxide and antimony; a carrier of a solid solution of barium sulfate and antimony oxide; a mixture of two or more of the above metal oxides; a mixture in which one or more of the above metal oxides are mixed with particles of one of titanium oxide, tin oxide, zinc oxide, or barium sulfate; and particles in which one or more of the above metal oxides are coated on particles of one of titanium oxide, tin oxide, zinc oxide, or barium sulfate.

Examples of the binder for use in the protective layer include known resins, such as polyamide resin, polyvinyl acetal resin, polyurethane resin, polyester resin, epoxy resin, polyketone resin, polycarbonate resin, polyvinyl ketone resin, polystyrene resin, polyacrylamide resin, polyimide resin, and polyamideimide resin. These resins may be crosslinked as required and used.

The thickness of the protective layer is preferably from 1 μm to 20 μm and more preferably from 2 μm to 10 μm.

The method for applying the coating liquid for forming the protective layer may be an ordinary method, such as a blade coating method, a wire bar coating method, a spray coating method, a dip coating method, a bead coating method, an air knife coating method, or a curtain coating method. The solvent used in the coating solution for forming the protective layer may be an ordinary organic solvent, such as dioxane, tetrahydrofuran, methylene chloride, chloroform, chlorobenzene, or toluene, or a mixture of two or more thereof. A solvent that hardly dissolves the photosensitive layer to which the coating solution is applied may be used.

### Image-Forming Device and Process Cartridge

Next, an image-forming device and a process cartridge according to the present exemplary embodiment are described below.

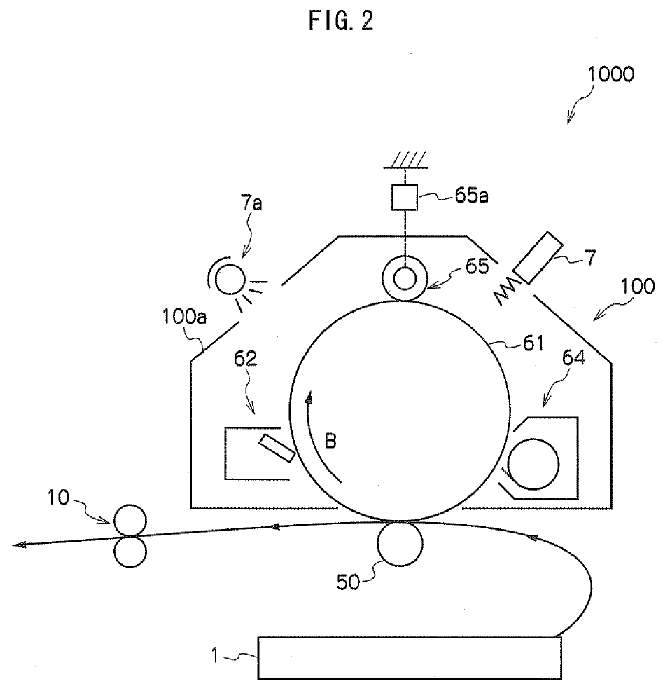

FIG. 2 is a view illustrating the overall structure of an example of the image-forming device according to the present exemplary embodiment.

An image-forming device 1000 is a black-and-white single-side output printer using an electrophotographic method.

The image-forming device 1000 includes an image holder 61, which is an electrophotographic photoreceptor that rotates in the direction of arrow B in FIG. 2 and a charging member 65, which is a charging unit that charges a surface of the image holder while rotating in contact with the image holder 61 and receiving electric power from a power source 65a. Here, the image holder 61 corresponds to an example of the electrophotographic photoreceptor according to the present exemplary embodiment.

The image-forming device 1000 includes: an exposure unit 7, which is an electrostatic latent image-forming unit that forms an electrostatic latent image having a higher electric potential than a surrounding area on the surface of the image holder 61 by emitting a laser beam toward the image holder 61; a developing device 64, which is an image formation unit that forms a toner image by developing the electrostatic latent image by attaching a monochromatic (black) toner to the electrostatic latent image formed on the surface of the image holder 61 using a developer containing the black toner; a transfer roll 50, which is a transfer unit that transfers the toner image formed on the surface of the image holder 61 to a sheet as a transfer-receiving material by pressing the sheet conveyed to the transfer roll 50 against the image holder 61 having the toner image formed thereon; a fixing unit 10, which is a fixing unit that fixes the transferred image to the sheet by applying heat and pressure to the transferred toner image on the sheet; a cleaning device 62, which is a cleaning unit that removes, by contacting the image holder 61, residual toner attached to and remaining on the surface of the image holder 61 after transferring of the toner image; and a charge eraser lamp 7a that erases the charge remaining on the image holder 61 after transferring of the toner image.

In the image-forming device 1000, both the charging member 65 and the image holder 61 are in the form of a roll extending in the direction perpendicular to the plane of FIG. 2, both ends of which are rotatably supported by a support member 100a. To the support member 100a, the cleaning device 62 and the developing device 64 are also connected. Thus, a process cartridge 100 is configured to include the charging member 65, the image holder 61, the cleaning device 62, and the developing device 64, which are integrated by the support member 100a.

By installing the process cartridge in the image-forming device 1000, the respective units constituting the process cartridge are resultantly installed in the image-forming device 1000. The process cartridge 100 corresponds to an example of the process cartridge of the present exemplary embodiment.

The image formation mechanism of the image-forming device 1000 is described below.

The image-forming device 1000 is provided with a toner cartridge (not illustrated) containing a black toner, and the toner cartridge supplies the toner to the developing device 64. Sheets to which toner images are to be transferred are stored in a sheet feed unit 1, and, when image formation is requested by a user, a sheet is conveyed from the sheet feed unit 1. A toner image is transferred to the sheet at the transfer roller 50, and then the sheet is conveyed to the left in FIG. 2. In FIG. 2, the sheet conveying path in the above process is illustrated as a path indicated by the leftward arrow. The sheet is then conveyed through the sheet conveying path to the fixing unit 10 at which the transferred image on the sheet is fixed, and then is discharged in the left direction.

When the charging member 65 charges the image holder 61, a voltage is applied to the charging member 65. With respect to the voltage range, a direct current voltage depends on a required charging potential of the image holder, and is preferably from 50 V to 2000 V (positive or negative) and more preferably from 100 V to 500 V (positive or negative). When an alternating voltage is superimposed, the peak-to-peak voltage may be from 400 V to 1800 V, preferably 800 V to 1600 V, and more preferably from 1200 V to 1600 V. The frequency of the alternating voltage may be from 50 Hz to 20,000 Hz and preferably from 100 Hz to 5,000 Hz.

As the charging member 65, it is possible to use a member in which at least one of an elastic layer, a resistive layer, a protective layer, or the like is provided on the outer circumferential surface of a core material. Even when the charging member 65 is not equipped with a driving unit, the charging member 65 is rotated at the same circumferential velocity as that of the image holder 61 by contacting the image holder 61 and functions as a charging unit. Alternatively, the charging member 65 may charge the surface of the image holder 61 while being rotated at a circumferential rate different from that of the image holder 61 by providing a driving unit to the charging member 65.

The exposure unit 7 may be an optical device that light exposes the surface of an electrophotographic photoreceptor imagewise, in accordance with the desired image, using a light source such as a semiconductor laser, an LED (light emitting diode), or a liquid crystal shutter.

The developing device 64 may be a known developing device using a normal or reversal developer, such as a one-component developer or a two-component developer. The shape of the toner for use in the developing device 64 is not particularly limited, and toner may have an amorphous shape, a spherical shape, or any other specific shape.

In the invention, a developing device of a toner-recycling system in which untransferred toner is collected in a developing machine, and the collected toner is reused may be used.

Examples of the transfer unit include, in addition to a contact charging member such as the transfer roller 50, a contact transfer charger using a belt, a film, a rubber blade, or the like, and a scorotron transfer charger or corotron transfer charger using a corona discharge.

The image-forming device according to the present exemplary embodiment is provided with a charge eraser lamp 7a. Therefore, when the electrophotographic photoreceptor is repeatedly used, a phenomenon in which the residual potential of the electrophotographic photoreceptor is carried over to the next cycle is prevented, as a result of which image quality is further improved. The image-forming device according to the present exemplary embodiment may be provided with the charge eraser lamp 7a as required.

The process cartridge according to the present exemplary embodiment integrally includes the electrophotographic photoreceptor according to the present exemplary embodiment and at least one of a charging unit that charges a surface of the electrophotographic photoreceptor, an electrostatic latent image-forming unit that forms an electrostatic latent image on the charged surface of the electrophotographic photoreceptor, an image-forming unit that forms a toner image by developing the electrostatic latent image formed on the surface of the electrophotographic photoreceptor using a developer, a transfer unit that transfers the toner image formed on the surface of the electrophotographic photoreceptor to a surface of a transfer-receiving material, and a cleaning unit that removes a residual toner on the surface of the electrophotographic photoreceptor after transferring. The process cartridge is attachable to and detachable from the main body of an image-forming device body.

### EXAMPLES

Hereinafter, the present exemplary embodiment will be more specifically described with reference to Examples and Comparative Examples, but is not limited to the following Examples.

### Example 1

A diameter of 30 mm×a length of 365 mm aluminum support having a surface roughened by honing is prepared. Separately, 30 parts by weight of organic zirconium compound (acetylacetone zirconium butyrate) and 3 parts by weight of organic silane compound (γ-aminopropyltrimethoxysilane) are added to 170 parts by weight of n-butyl alcohol in which 4 parts by weight of polyvinyl butyral resin (trade name: S-LEC BM-S, manufactured by Sekisui Chemical Co., Ltd.) is dissolved, followed by mixing by stirring, thereby obtaining a coating liquid for forming an undercoat layer. The coating liquid is coated on the aluminum support by dip coating, and is air-dried for 5 minutes at room temperature (24° C.). Thereafter, the temperature of the support is increased to 50° C. in 10 minutes, put in a constant temperature and humidity chamber of 50° C. and 85% RH (dew point: 47° C.), and subjected to humidification curing promoting treatment for 20 minutes. Thereafter, the resultant is put in a hot air drying device, and dried at 155° C. for 10 minutes, thereby forming an undercoat layer.

Next, a mixture containing 15 parts by weight of chlorogallium phthalocyanine as a charge generating material, 10 parts by weight of vinyl chloride-vinyl acetate copolymer resin (trade name: VMCH, manufactured by Nippon Union Carbide Co.), and 300 parts by weight of n-butyl alcohol is dispersed in a sand mill for 4 hours. The obtained dispersion liquid is coated on the undercoat layer by dip coating, and dried at 120° C. for 6 minutes, thereby forming a charge generating layer having a thicknesses of 0.2 μm.

Next, A: 0.5 part by weight of tetrafluoroethylene resin particles (average primary particle diameter of 0.2 μm) and 0.01 part by weight of a fluorinated alkyl group-containing copolymer containing the repeating unit represented by the following Structural Formula (random copolymer having a weight average molecular weight of 50,000, l:m=1:1, s=1, and n=60) are mixed with 4 parts by weight of tetrahydrofuran and 1 part by weight of toluene by stirring for 48 hours while maintaining the liquid temperature at 20° C., thereby obtaining a tetrafluoroethylene resin particle suspension liquid (Liquid A).

Next, B: 2 parts by weight of N,N′-bis(3-methylphenyl)-N,N′-diphenylbenzidine and 2 parts by weight of N,N′-bis(3,4-dimethylphenyl)biphenyl-4-amine as charge transporting substances, 6 parts by weight of bisphenol Z polycarbonate resin (viscosity average molecular weight: 40,000), 0.1 part by weight of 2,6-di-tert-butyl-4-methylphenol as an antioxidant, 24 parts by weight of tetrahydrofuran, and 11 parts by weight of toluene are mixed to form a solution (Liquid B).

The liquid A is added to the liquid B, and mixed by stirring. Thereafter, using a high pressure homogenizer (manufactured by Yoshida Kikai Co., Ltd.) provided with a flow-through chamber with a fine flow path, the resultant mixture liquid is repeatedly dispersed 6 times at an increased pressure of 500 kgf/cm². Then, 8 ppm of dimethyl silicone oil (trade name: KP-340, manufactured by Shin-Etsu Chemical Co., Ltd.) is added thereto, followed by stirring, thereby obtaining a coating liquid for forming a charge transporting layer.

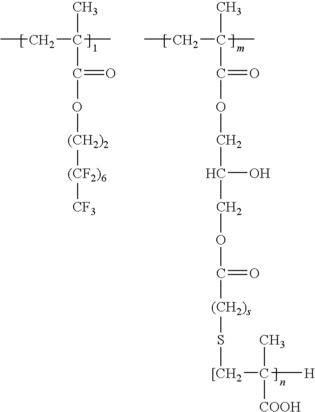

The fluorinated alkyl group-containing copolymer used in Example 1 is purified by the following procedure.

Specifically, after the synthesis of the fluorinated alkyl group-containing copolymer, the fluorinated alkyl group-containing copolymer is heated at 160° C. for 2 hours, dissolved in tetrahydrofuran, irradiated with ultrasonic waves of 100 kHz for 30 minutes, added dropwise to methanol, and stirred. The precipitate is isolated from methanol by suction filtration. The collected precipitate is dried at 80° C. for 24 hours by a vacuum dryer. Again, the resultant is dissolved in tetrahydrofuran, irradiated with ultrasonic waves of 100 kHz for 30 minutes, added dropwise to methanol, and stirred. The precipitate is isolated from methanol by suction filtration. The collected precipitate is dried at 80° C. for 24 hours by a vacuum dryer, thereby obtaining a fluorinated alkyl group-containing copolymer.

The coating liquid is applied onto the charge generating layer, and dried at 120° C. for 40 minutes to form a charge transporting layer having a thickness of 34 μm, thereby obtaining a target electrophotographic photoreceptor.

### <Evaluation>

The following tests are carried out using the electrophotographic photoreceptor thus obtained. The obtained results are shown in Table 1.

### (Image Evaluation, Remaining Film Thickness)

The electrophotographic photoreceptor obtained as described above is installed in a drum cartridge of a black-and-white printer DOCUCENTRE-III C3300 (trade name, manufactured by Fuji Xerox Co., Ltd.), and compatibility to repeated use is checked. A 50000-sheet printing test based on an A4-image having an area coverage of 5% is performed under a low temperature and low humidity environment of 10° C. and 15% RH, using A4 plain sheets (trade name: C², manufactured by Fuji Xerox Co., Ltd.). The film thickness of the electrophotographic photoreceptor before printing test and after 50000-sheet printing is measured by an eddy current thickness meter to determine the remaining film thickness of the electrophotographic photoreceptor. By comparing the remaining film thickness with the film thickness before the printing test, the wear amount of the photoreceptor is calculated. At an early stage of the printing test and after the 50000-sheet printing test, an image having a solid patch of a 50% halftone image is output at five places of the upper left, the upper right, the center, the lower left, and the lower right. The image density of the five solid patches at the upper left, the upper right, the center, the lower left, and the lower right is measured using an X-Rite386 Spectrodensitmeter (trade name) manufactured by X-Rite, thereby determining the difference between the maximum density and the minimum density.

The remaining film thickness of the charge transporting layer (photoreceptor wear amount) is evaluated based on the following criteria.
A: the remaining film thickness≧14 μm
B: the remaining film thickness<14 μm

The in-plane image density unevenness (difference between the maximum density and the minimum density) is evaluated based on the following criteria.
A: the difference≧0.2
B: the difference<0.2

### (Measurement and Evaluation of Residual Potential and Residual Potential Maintenance)

The electrophotographic photoreceptor is charged by a scorotron charging device having a grid applying voltage of −700V under a low temperature and low humidity (10° C., 15% RH) environment. Next, the electrophotographic photoreceptor 1 second after the charging is discharged by irradiation with light of 10 mJ/m² using a 780 nm semiconductor laser.

Subsequently, the electrophotographic photoreceptor 3 seconds after the discharging is irradiated with red LED light of 50 mJ/m² so as to remove a charge. Then, the electric potential (V) of the surface of the electrophotographic photoreceptor at this time is measured, and the obtained value is defined as the value of residual potential.

Moreover, the electrophotographic photoreceptor after the 50000-sheet printing test is also measured with respect to the residual potential according to the same method as above, and the obtained value is defined as the value of residual potential maintenance.

The residual potential is evaluated based on the following criteria.
A: residual potential<20 V
B: residual potential≧20 V

The residual potential maintenance is evaluated based on the following criteria.
A: residual potential maintenance<100 V
B: residual potential maintenance≧100 V

### (Analysis of the Amount of Quaternary Ammonium Salt in Surface Layer)

The content of quaternary ammonium salt is quantified by the above-described method using a sample obtained by peeling off and pulverizing the charge transporting layer of the electrophotographic photoreceptor.

### Example 2

An electrophotographic photoreceptor is produced in the same manner as in Example 1, except that the 0.01 part by weight of the fluorinated alkyl group-containing copolymer used in Example 1 is replaced by 0.01 part by weight of a fluorinated alkyl group-containing copolymer having the following structure (random copolymer having a weight average molecular weight of 15,000, l:m=1:1, n=60). Evaluations are performed using the obtained electrophotographic photoreceptor in the same manner as in Example 1. The obtained results are shown in Table 1.

The fluorinated alkyl group-containing copolymer used in Example 2 is purified in the same manner as in Example 1.

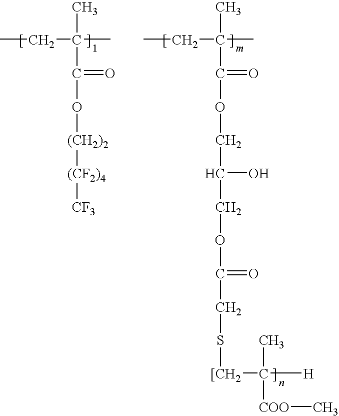

### Example 3

An electrophotographic photoreceptor is produced in the same manner as in Example 1, except that the 0.01 part by weight of the fluorinated alkyl group-containing copolymer used in Example 1 is replaced by 0.01 part by weight of a fluorinated alkyl group-containing copolymer having the following structure (random copolymer having a weight average molecular weight of 15,000, l:m=1:1, n=60). Evaluations are performed using the obtained electrophotographic photoreceptor in the same manner as in Example 1. The obtained results are shown in Table 1.

The fluorinated alkyl group-containing copolymer used in Example 3 is purified in the same manner as in Example 1.

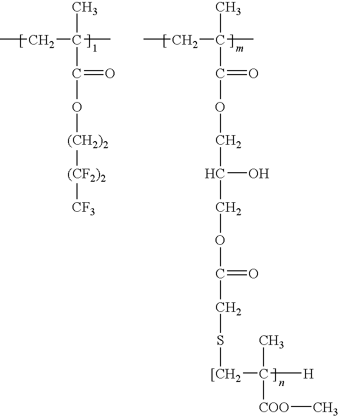

### Example 4

An electrophotographic photoreceptor is produced in the same manner as in Example 1, except changing the purification method of the fluorinated alkyl group-containing copolymer to the following method.

Specifically, after the synthesis of the fluorinated alkyl group-containing copolymer, the fluorinated alkyl group-containing copolymer is dissolved in tetrahydrofuran, and added dropwise to methanol. The precipitate is isolated from methanol by suction filtration. The collected precipitate is dried at 50° C. for 24 hours by a vacuum dryer. Again, the resultant is dissolved in tetrahydrofuran, and added dropwise to methanol. The precipitate is isolated from methanol by suction filtration. The collected precipitate is dried at 50° C. for 24 hours by a vacuum dryer. Further, the resultant is heated at 150° C. for 2 hours, dissolved in tetrahydrofuran again, irradiated with ultrasonic waves of 100 kHz for 30 minutes, added dropwise to methanol, and stirred. The precipitate is isolated from methanol by suction filtration. The collected precipitate is dried at 80° C. for 24 hours by a vacuum dryer, thereby obtaining a fluorinated alkyl group-containing copolymer.

Evaluations are performed using the obtained electrophotographic photoreceptor in the same manner as in Example 1. The obtained results are shown in Table 1.

### Example 5

An electrophotographic photoreceptor is produced in the same manner as in Example 1, except that the 0.01 part by weight of the fluorinated alkyl group-containing copolymer used in Example 1 is replaced by 0.01 part by weight of a fluorinated alkyl group-containing copolymer having the following structure (random copolymer having a weight average molecular weight of 15,000, l:m=1:1, n=60). Evaluations are performed using the obtained electrophotographic photoreceptor in the same manner as in Example 1. The obtained results are shown in Table 1.

The fluorinated alkyl group-containing copolymer used in Example 5 is purified in the same manner as in Example 1.

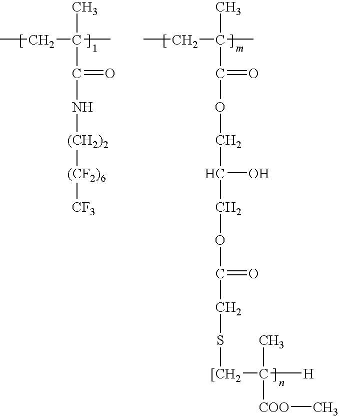

### Comparative Example 1

An electrophotographic photoreceptor is produced in the same manner as in Example 1, except that the amount of the fluorinated alkyl group-containing copolymer is changed to 0.03 part by weight. Evaluations are performed using the obtained electrophotographic photoreceptor in the same manner as in Example 1. The obtained results are shown in Table 1.

The fluorinated alkyl group-containing copolymer used in Comparative Example 1 is purified in the same manner as in Example 1.

### Comparative Example 2

An electrophotographic photoreceptor is produced in the same manner as in Example 1, except that the amount of the fluorinated alkyl group-containing copolymer is changed to 0.05 part by weight. Evaluations are performed using the obtained electrophotographic photoreceptor in the same manner as in Example 1. The obtained results are shown in Table 1.

The fluorinated alkyl group-containing copolymer used in Comparative Example 2 is purified in the same manner as in Example 1.

### Comparative Example 3

An electrophotographic photoreceptor is produced in the same manner as in Example 1, except changing the purification method of the fluorinated alkyl group-containing copolymer to the following method.

Specifically, after the synthesis of the fluorinated alkyl group-containing copolymer, the fluorinated alkyl group-containing copolymer is dissolved in tetrahydrofuran, and added dropwise to methanol. The precipitate is isolated from methanol by suction filtration. The collected precipitate is dried at 50° C. for 24 hours by a vacuum dryer. Again, the resultant is dissolved in tetrahydrofuran, and added dropwise to methanol. The precipitate is isolated from methanol by suction filtration. The collected precipitate is dried at 80° C. for 24 hours by a vacuum dryer, thereby obtaining a fluorinated alkyl group-containing copolymer.

Evaluations are performed using the obtained electrophotographic photoreceptor in the same manner as in Example 1. The obtained results are shown in Table 1.

TABLE 1

| | Remaining film | | | | Residual | | Initial image | | Quaternary |
|---|---|---|---|---|---|---|---|---|---|
| | thickness of charge | | Residual | | potential | | quality | Image quality after | ammonium |
| | transporting layer | | potential | | maintenance | | (density | 50000-sheet printing test | salt amount |
| Example No. | (μm) | | (V) | | (V) | | unevenness) | (density unevenness) | (ppm) |
| Example 1 | 14.8 | A | 10 | A | 70 | A | A | A | 40 |
| Example 2 | 14.9 | A | 15 | A | 78 | A | A | A | 45 |
| Example 3 | 14.5 | A | 13 | A | 88 | A | A | A | 50 |
| Example 4 | 14.9 | A | 15 | A | 78 | A | A | A | 40 |
| Example 5 | 14.1 | A | 12 | A | 97 | A | A | A | 30 |
| Comparative | 14.9 | A | 25 | B | 150 | B | A | B | 100 |
| Example 1 | | | | | | | | | |
| Comparative | 14.9 | A | 37 | B | 242 | B | A | B | 170 |
| Example 2 | | | | | | | | | |
| Comparative | 14.8 | A | 25 | B | 168 | B | A | B | 60 |
| Example 3 | | | | | | | | | |

As shown in Table 1, the difference in residual potential between before the 50000-sheet printing test and after the 50000-sheet printing test in Examples is in the range of 60 V to 85 V while the residual potential difference in Comparative Examples is larger (in the range of 125 V to 205 V) than Examples. Therefore, it is found that a higher content of quaternary ammonium salt results in a tendency to cause a great difference in the residual potential between before and after the 50000-sheet printing test.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments are chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An electrophotographic photoreceptor comprising a conductive support and, on the conductive support, at least a photosensitive layer,
the electrophotographic photoreceptor comprising a surface layer that may be the same as or different from the photosensitive layer and that includes fluororesin particles and a fluorinated alkyl group-containing copolymer containing a repeating unit represented by the following Structural Formula A, and
the content of quaternary ammonium salt in the surface layer being about 50 ppm or less: 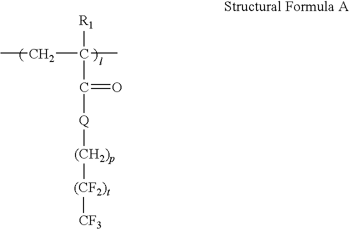
wherein, in Structural Formula A, l represents a positive number of 1 or more; p represents 0 or a positive number of 1 or more; t represents a positive number of from 1 to 7; R₁ represents a hydrogen atom or an alkyl group; and Q represents —O— or —NH—.

2. The electrophotographic photoreceptor according to claim 1, wherein t represents a number of from 2 to 6.

3. The electrophotographic photoreceptor according to claim 1, wherein the fluorinated alkyl group-containing copolymer further contains a repeating unit represented by the following Structural Formula B: 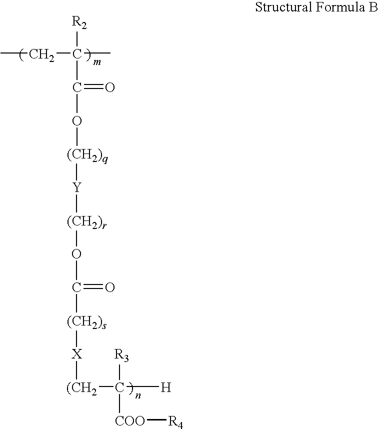
wherein, in Structural Formula B, m and n each independently represent a positive number of 1 or more; q, r, and s each independently represent 0 or a positive number of 1 or more; R₂, R₃, and R₄ each independently represent a hydrogen atom or an alkyl group; X represents an alkylene chain, a halogen-substituted alkylene chain, —S—, —O—, —NH—, or a single bond; Y represents an alkylene chain, a halogen-substituted alkylene chain, —(C_{z}H_{2z-1}(OH))—, or a single bond; and z represents a positive number of 1 or more.

4. The electrophotographic photoreceptor according to claim 1, wherein the fluorinated alkyl group-containing copolymer further contains a repeating unit represented by the following Structural Formula C: 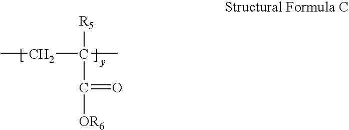
wherein, in Structural Formula C, R₅ and R₆ each independently represent a hydrogen atom or an alkyl group; and y represents a positive number of 1 or more.

5. The electrophotographic photoreceptor according to claim 1, wherein the fluororesin particles include a tetrafluoroethylene resin.

6. The electrophotographic photoreceptor according to claim 1, wherein the content of the fluororesin particles is from about 1 weight % to about 15 weight % with respect to the total solid content of the surface layer.

7. The electrophotographic photoreceptor according to claim 1, wherein the content of the fluorinated alkyl group-containing copolymer in the surface layer is from about 1 weight % to about 5 weight % with respect to the content of the fluororesin particles in the surface layer.

8. An image-forming device, comprising:
an electrophotographic photoreceptor comprising a conductive support and, on the conductive support, at least a photosensitive layer, the electrophotographic photoreceptor comprising a surface layer that may be the same as or different from the photosensitive layer and that includes fluororesin particles and a fluorinated alkyl group-containing copolymer containing a repeating unit represented by the following Structural Formula A, the content of quaternary ammonium salt in the surface layer being about 50 ppm or less;
a charging unit that charges a surface of the electrophotographic photoreceptor;
an electrostatic latent image-forming unit that forms an electrostatic latent image on the charged surface of the electrophotographic photoreceptor;
an image-forming unit that forms a toner image by developing the electrostatic latent image formed on the surface of the electrophotographic photoreceptor using a developer; and
a transfer unit that transfers the toner image formed on the surface of the electrophotographic photoreceptor to a surface of a transfer-receiving material: 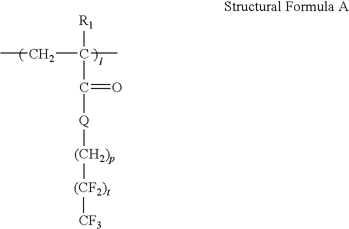
wherein, in Structural Formula A, l represents a positive number of 1 or more; p represents 0 or a positive number of 1 or more; t represents a positive number of from 1 to 7; R₁ represents a hydrogen atom or an alkyl group; and Q represents —O— or —NH—.

9. The image-forming device according to claim 8, wherein the fluorinated alkyl group-containing copolymer further contains a repeating unit represented by the following Structural Formula B: 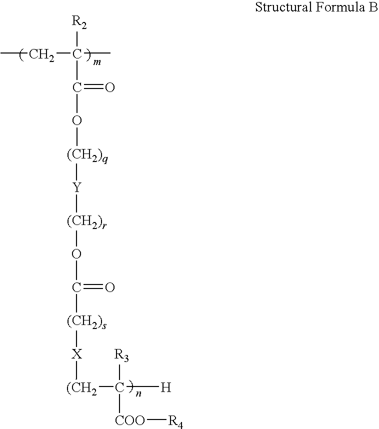
wherein, in Structural Formula B, m and n each independently represent a positive number of 1 or more; q, r, and s each independently represent 0 or a positive number of 1 or more; R₂, R₃, and R₄ each independently represent a hydrogen atom or an alkyl group; X represents an alkylene chain, a halogen-substituted alkylene chain, —S—, —O—, —NH—, or a single bond; Y represents an alkylene chain, a halogen-substituted alkylene chain, —(C_{z}H_{2z-1}(OH))—, or a single bond; and z represents a positive number of 1 or more.

10. The image-forming device according to claim 8, wherein the fluorinated alkyl group-containing copolymer further contains a repeating unit represented by the following Structural Formula C: 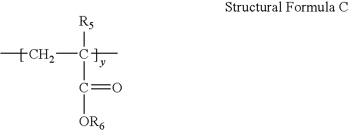
wherein, in Structural Formula C, R₅ and R₆ each independently represent a hydrogen atom or an alkyl group; and y represents a positive number of 1 or more.

11. The image-forming device according to claim 8, wherein the content of the fluorinated alkyl group-containing copolymer in the surface layer is from about 1 weight % to about 5 weight % with respect to the content of the fluororesin particles in the surface layer.

12. A process cartridge comprising, integrally:
an electrophotographic photoreceptor comprising a conductive support and, on the conductive support, at least a photosensitive layer, the electrophotographic photoreceptor comprising a surface layer that may be the same as or different from the photosensitive layer and that includes fluororesin particles and a fluorinated alkyl group-containing copolymer containing a repeating unit represented by the following Structural Formula A, the content of quaternary ammonium salt in the surface layer being about 50 ppm or less; and
at least one of a charging unit that charges a surface of the electrophotographic photoreceptor, an electrostatic latent image-forming unit that forms an electrostatic latent image on the charged surface of the electrophotographic photoreceptor, an image-forming unit that forms a toner image by developing the electrostatic latent image formed on the surface of the electrophotographic photoreceptor using a developer, a transfer unit that transfers the toner image formed on the surface of the electrophotographic photoreceptor to a surface of a transfer-receiving material, or a cleaning unit that removes a residual toner on the surface of the electrophotographic photoreceptor after the transfer,
the process cartridge being attachable to and detachable from a main body of an image-forming device: 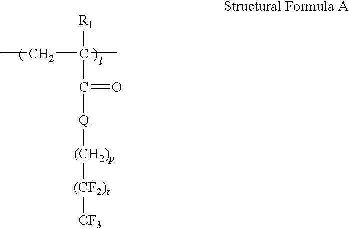
wherein, in Structural Formula A, l represents a positive number of 1 or more; p represents 0 or a positive number of 1 or more; t represents a positive number of from 1 to 7; R₁ represents a hydrogen atom or an alkyl group; and Q represents —O— or —NH—.

13. The process cartridge according to claim 12, wherein the fluorinated alkyl group-containing copolymer further contains a repeating unit represented by the following Structural Formula B: 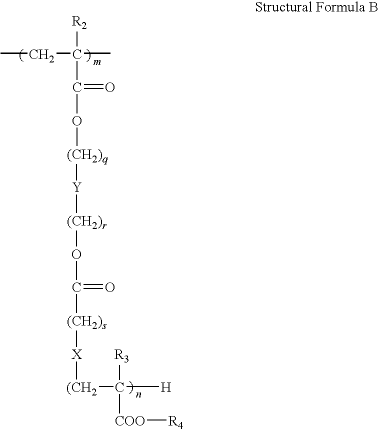
wherein, in Structural Formula B, m and n each independently represent a positive number of 1 or more; q, r, and s each independently represent 0 or a positive number of 1 or more; R₂, R₃, and R₄ each independently represent a hydrogen atom or an alkyl group; X represents an alkylene chain, a halogen-substituted alkylene chain, —S—, —O—, —NH—, or a single bond; Y represents an alkylene chain, a halogen-substituted alkylene chain, —(C_{z}H_{2z-1}(OH))—, or a single bond; and z represents a positive number of 1 or more.

14. The process cartridge according to claim 12, wherein the fluorinated alkyl group-containing copolymer further contains a repeating unit represented by the following Structural Formula C: 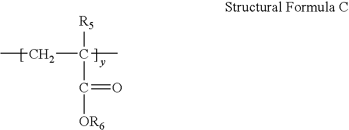
wherein, in Structural Formula C, R₅ and R₆ each independently represent a hydrogen atom or an alkyl group; and y represents a positive number of 1 or more.

15. The process cartridge according to claim 12, wherein the content of the fluorinated alkyl group-containing copolymer in the surface layer is from about 1 weight % to about 5 weight % with respect to the content of the fluororesin particles in the surface layer.
